(19) United States
(12) Patent Application Publication
(10) Pub. No.: US 2013/0076635 A1
(43) Pub. Date: Mar. 28, 2013

(54) MEMBRANE TOUCH KEYBOARD STRUCTURE FOR NOTEBOOK COMPUTERS

(71) Applicant: Yu-Kai LIN, Cayman Islands (IO)

(72) Inventor: Yu-Kai LIN, Cayman Islands (IO)

(73) Assignee: KO JA (CAYMAN) CO., LTD.

(21) Appl. No.: 13/245,810

(22) Filed: Sep. 26, 2011

(51) Int. Cl. G06F 3/02

(52) U.S. Cl. 345/169

(57) ABSTRACT

A membrane touch keyboard structure for notebook computers comprises a panel, a sensing layer, a backlight layer and a base layer. The panel includes hot key patterns, a key group pattern, a cursor control pattern, and a sensing key pattern. A first sensing block, first electrode blocks, a second sensing block, a third electrode block or a third sensing block, and a fourth sensing block correspond to sensing layers of the hot key patterns, key group pattern, cursor control pattern, and sensing key pattern. The sensing layers are resistive/capacitive films. The membrane touch keyboard and the touch panel are integrated to reduce the thickness of the notebook computer. When any hot key pattern, key group pattern, cursor control pattern or sensing key pattern is touched, the touch is sensed by the sensing layer to generate and output a sensing control signal to the notebook computer for an operation.

### FIELD OF THE INVENTION

The present invention relates to a computer keyboard, in particular to a membrane touch keyboard structure for notebook computers.

### BACKGROUND OF THE INVENTION

Keyboard is one of the necessary peripherals of desktop or notebook computers provided for users to input an operation instruction to execute a specific function.

Besides a touch panel (for controlling a cursor movement), present existing keyboard used for notebook computers usually comes with functional keys, a keypad and hot keys which are press keys with a mechanical structure. For example, each press key has a key cap, and after the key cap is pressed, the internal assembly of the key cap presses at a supporting frame and an elastic rubber layer, such that the elastic rubber layer presses a thin-film or rigid printed circuit board to generate a signal to be input into a host computer.

The touch panels (for controlling the cursor movement), functional keys, keypad and hot keys of the notebook computer are manufactured separately, and then installed on to the notebook computer one by one, thus involving relatively more complicated manufacturing process and consuming more time and labor.

Since the functional keys, keypad and hot keys of the keyboard of the notebook computer have the design of a mechanical structure, noises will be produced when the keys are pressed and hit. After being used for a long time, the structure of the press keys exerted with an external force will damage the keys easily. As a result, the operating signal of the press key cannot be inputted. In addition, each of the functional keys, keypad and hot keys of the keyboard of the notebook computer with the mechanical structure has a specific height, so that the keyboard installed on the notebook computer will have a certain thickness, so that the notebook computer cannot be carried by users easily and the conventional keyboard for notebook computers is incompliance with the light, thin, short and compact design of modern electronic products.

In view of the aforementioned problems, the inventor of the present invention conducted extensive researches and experiments and finally provided a feasible design to overcome the aforementioned problems.

### SUMMARY OF THE INVENTION

Therefore, it is a primary objective of the present invention to overcome the shortcomings of the prior art by integrating a membrane touch keyboard and a touch panel (for controlling the cursor movement), so that the original functional keys, keypad and hot key on the keyboard of the notebook computer are touch keys for lowering the noises produced during the use of the keyboard, and the touch panel, functional keys, keypad and hot key can be manufactured simultaneously to reduce the manufacturing time, labor and cost and decrease the thickness of the notebook computer to comply with the light, thin, short and compact design of modern electronic products.

To achieve the foregoing objective, the present invention provides a membrane touch keyboard structure for notebook computers, comprising:

a panel, including a key group pattern and a cursor control pattern; and

a sensing layer, including a first transparent layer and a second transparent layer, and the first transparent layer including a first front side and a first backside, and the first backside including a plurality of first electrode blocks and a second sensing block, and the plurality of first electrode blocks corresponding to the key group pattern, and the second sensing block corresponding to the cursor control pattern;

thereby, the second transparent layer includes a second front side and a second backside, and the second front side includes a plurality of second electrode blocks corresponding to the first electrode blocks respectively, and the second electrode block includes a convex body provided for forming a spacing between the corresponding first electrode block and second electrode block.

Wherein, the panel further includes a plurality of hot key patterns and at least one sensing key pattern.

Wherein, the key group pattern, the cursor control pattern, the plurality of hot key patterns and the sensing key pattern includes a touch layer each.

Wherein, the touch layer is composed of a plurality of protrusions.

Wherein, the panel is a transparent plastic sheet.

Wherein, the first transparent layer and the second transparent layer are composed of two transparent plastic sheets.

Wherein, the first backside further includes a plurality of first sensing blocks and a third electrode block, and the plurality of first sensing blocks corresponds to the plurality of hot key patterns, and the third electrode block corresponds to the sensing key pattern.

Wherein, the second front side further includes a plurality of second electrode blocks corresponding to the third electrode block, and the second electrode block includes a convex body, such that the convex body has a spacing formed between the corresponding second electrode block and third electrode block.

Wherein, the first sensing block is coupled to a plurality of transmission lines.

Wherein, the plurality of first electrode blocks is electrically coupled, and the first electrode block is coupled to a plurality of signal transmission lines.

Wherein, the third electrode block and the first electrode block are electrically coupled.

Wherein, the plurality of second electrode block is electrically coupled, and the second electrode block is coupled to a plurality of signal transmission lines.

Wherein, a backlight layer is further provided and installed under the sensing layer, and the backlight layer is a transparent plastic sheet, having a plurality of light emitting elements corresponding to the first sensing block and the first electrode block and the second electrode block, and each of the light emitting elements is electrically coupled and has a power transmission line extended from the light emitting diode.

Wherein, the light emitting element is a light emitting diode (LED), an electroluminescent panel or an LED backlight panel.

Wherein, a base layer is further provided for carrying a combined member of the panel, the sensing layer and the backlight layer.

To achieve the aforementioned objective, the present invention further provides a membrane touch keyboard structure for notebook computers, comprising:

a panel, including a key group pattern and a cursor control pattern; and a sensing layer, including a first transparent layer, and the first transparent layer including a first front side and a first backside, and the first backside including a plurality of third electrode blocks and a second sensing block, and the plurality of third electrode blocks corresponding to the key group pattern, and the second sensing block corresponding to the cursor control pattern.

Wherein, the panel further includes a plurality of hot key patterns and a sensing key pattern.

Wherein, the first backside includes a plurality of first sensing blocks and a fourth sensing block and the plurality of first sensing blocks corresponds to the plurality of hot key patterns, and the fourth sensing block corresponds to the sensing key pattern.

Wherein, the panel is a transparent plastic sheet.

Wherein, the first sensing block is coupled to a plurality of transmission lines.

Wherein, the plurality of third sensing blocks is electrically coupled, and the third sensing block is coupled to a plurality of signal transmission lines.

Wherein, the fourth sensing block and the third sensing block are electrically coupled.

Wherein, a backlight layer is further provided and installed under the sensing layer, and a transparent plastic sheet is disposed thereon, and a plurality of light emitting elements corresponding to the first sensing block and the third sensing block is disposed thereon, and each of the light emitting elements is electrically coupled, and has a power transmission line extended from the light emitting element.

Wherein, the light emitting element is a light emitting diode, an electroluminescent panel or an LED backlight panel.

Wherein, a base layer is further provided for carrying a combined member of the panel, the sensing layer and the backlight layer.

Wherein, the plurality of hot key patterns, the key group pattern, the cursor control pattern and the sensing key pattern include a surface touch layer disposed on a surface thereof.

Wherein, the touch layer is composed of a plurality of protrusions.

### BRIEF DESCRIPTION OF THE DRAWINGS

FIG. 1 is a perspective view of a notebook computer of the present invention;

FIG. 2 is a perspective view of a membrane touch keyboard structure of the present invention;

FIG. 3 is an exploded view of a membrane touch keyboard structure of the present invention;

FIG. 4 is a close-up view of a first transparent layer of a sensing layer as depicted in FIG. 3;

FIG. 5 is a close-up view of a second transparent layer of a sensing layer as depicted in FIG. 3;

FIG. 6 is a close-up view of a backlight layer as depicted in FIG. 3;

FIG. 7 is a side cross-sectional view of FIG. 2;

FIG. 8 is a close-up view of FIG. 7;

FIG. 9 is an exploded view of another preferred embodiment of the present invention; and

FIG. 10 is a side cross-sectional view of FIG. 9.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

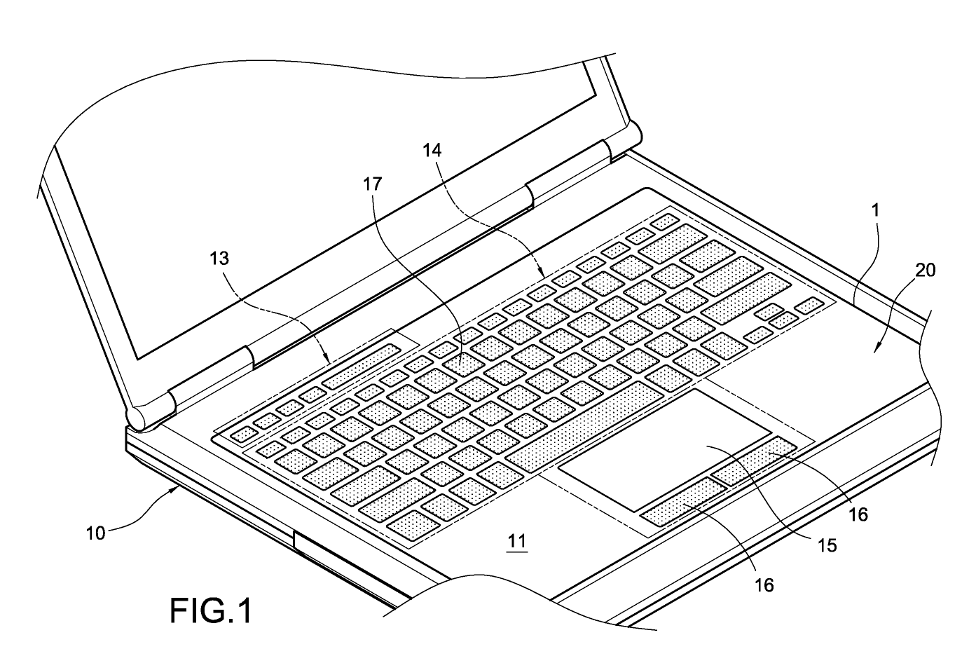

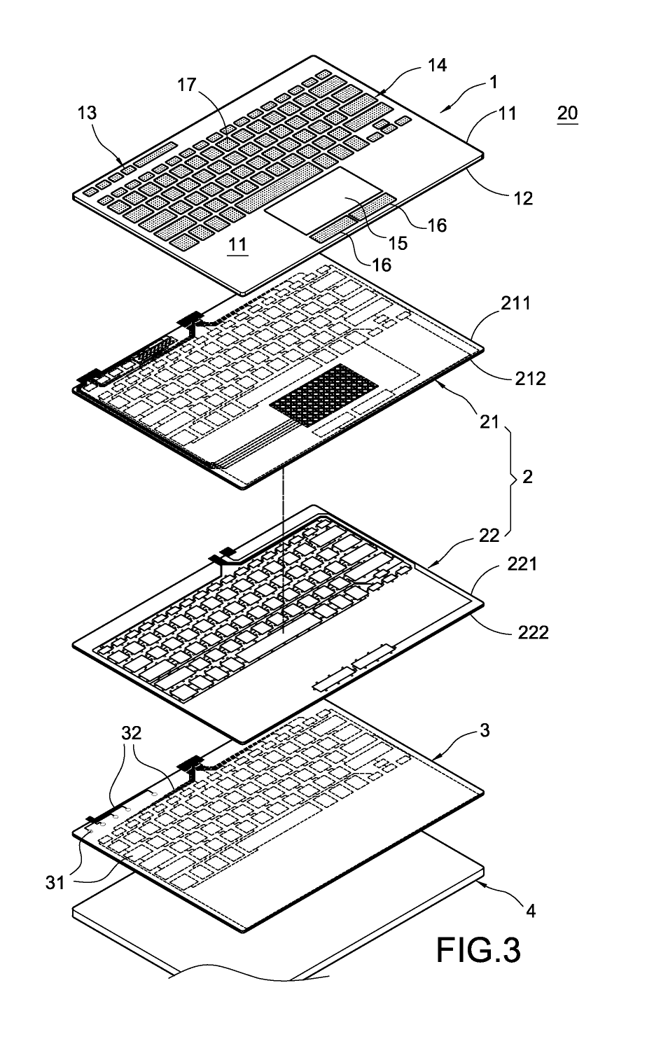

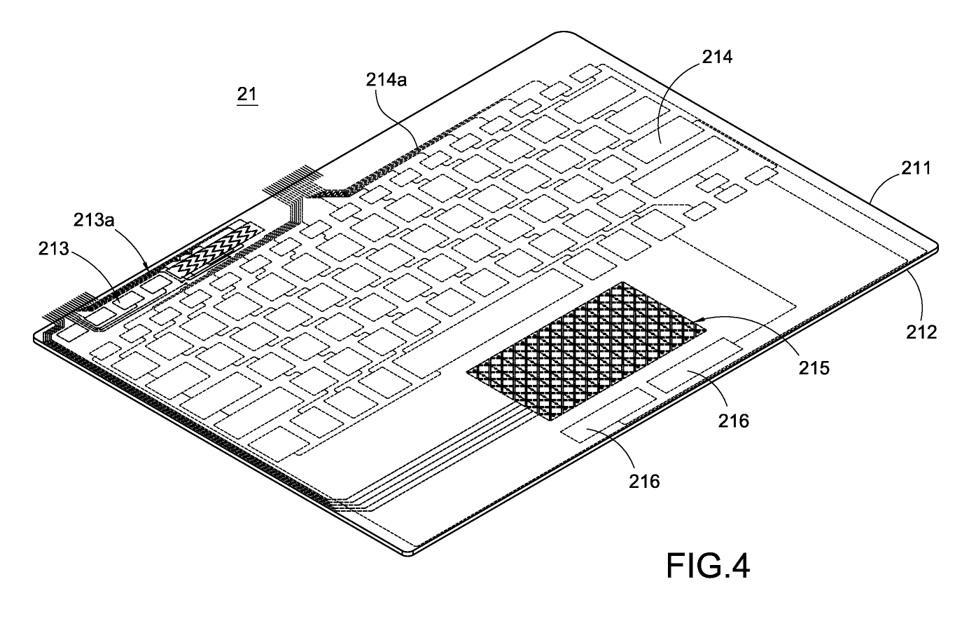

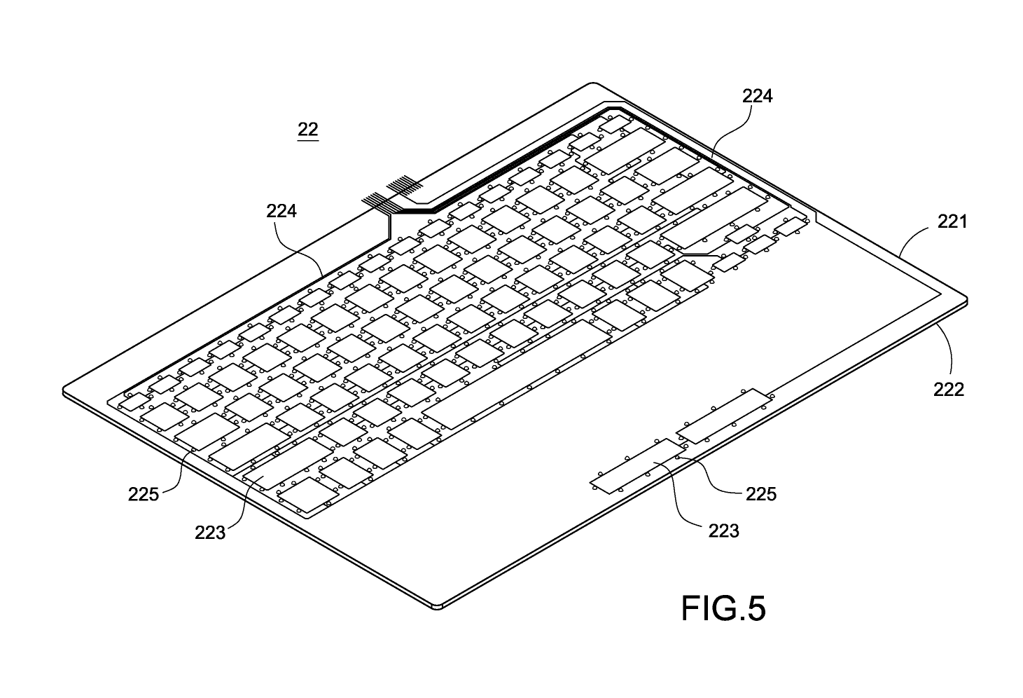

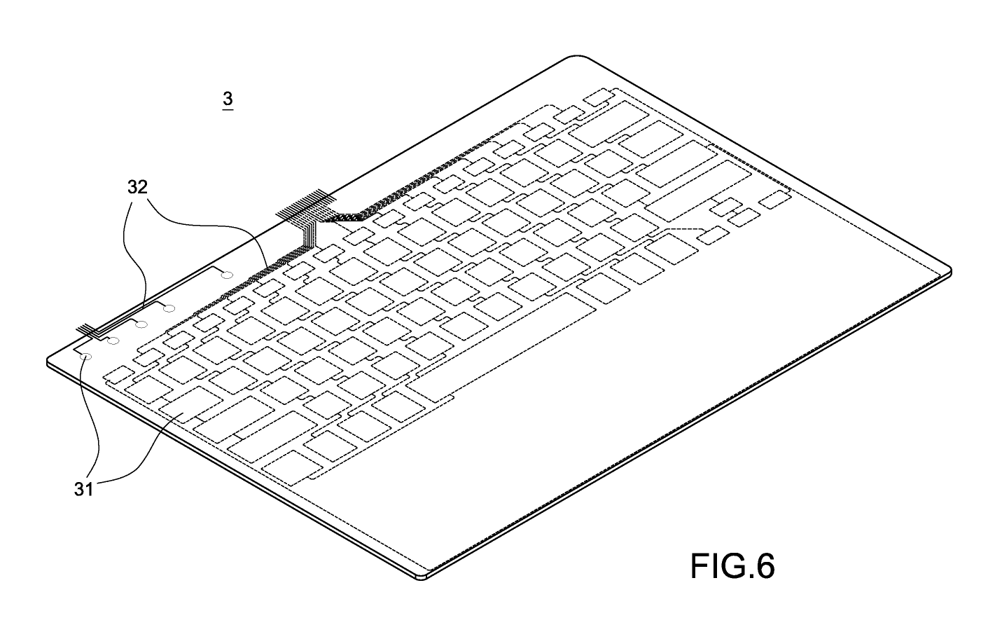

With reference to FIGS. 1 to 3 for the perspective view of a notebook computer, and the perspective view and exploded view of a membrane touch keyboard structure in accordance with the present invention, and FIGS. 4 and 5 for close-up view of a sensing layer as depicted in FIG. 3, and FIG. 6 for a close-up view of a backlight layer as depicted in FIG. 3 respectively, the notebook computer 10 includes a membrane touch keyboard 20, and the membrane touch keyboard 20 comprises: a panel 1, a sensing layer 2, a backlight layer 3 and a base layer 4.

The panel 1 is a transparent plastic sheet having a first surface 11 and a second surface 12, and the first surface 11 includes a plurality of hot key patterns 13, a key group pattern 14, a cursor control pattern 15, a sensing key pattern (such as left and right key patterns) 16. After a user touches the hot key pattern 13, a corresponding function such as logging on the Internet can be executed, and the user simply presses this key to connect the computer to the network immediately. The key group pattern 14 is provided for users to input an operation instruction such as writing various symbols, texts, numerals, and upper and lower case letters or switching functions. The cursor control pattern 15 is provided for users to control the cursor, and the sensing key pattern 16 is provided for the users to click or confirm a function. In the plurality of hot key patterns 13, a touch layer 17 is disposed on the surface of each of the key group pattern 14, the cursor control pattern 15 and the sensing key pattern (left and right key patterns) 16, and the touch layer 17 lets the users feel the touch of the press key. In this figure, the touch layer 17 is composed of a plurality of protrusions.

The sensing layer 2 is disposed under the panel 1 and composed of two transparent plastic sheets which are a first transparent layer 21 and a second transparent layer 22. The first transparent layer 21 includes a first front side 211 and a first backside 212. The first backside 212 includes a plurality of first sensing blocks 213, a plurality of first electrode blocks 214, a second sensing block 215, and a third electrode block 216. The plurality of first sensing blocks 213 corresponds to the plurality of hot key patterns 13, and the first sensing block 213 is coupled to a plurality of transmission lines 213a. The plurality of first electrode blocks 214 is electrically coupled, and the first electrode block 214 is coupled to a plurality of signal transmission lines 214a, and the plurality of first electrode blocks 214 corresponds to the key group pattern 14. The second sensing block 215 corresponds to the cursor control pattern 15. The third electrode block 216 and the first electrode block 214 are electrically coupled, and the third electrode block 216 corresponds to the sensing key pattern 16. In addition, the second transparent layer 22 includes a second front side 221 and a second backside 222, and the second front side 221 includes a plurality of second electrode block 223, and the second electrode block 223 is electrically coupled, and the second electrode block 223 is coupled to at least one signal transmission line 224. The plurality of second electrode blocks 223 corresponds to the first electrode block 214 and the third electrode block 216, and the second electrode block 223 have a convex body 225 each, and the convex body 225 lets the first electrode block 214 form a spacing between the corresponding third electrode block 216 and second electrode block 223.

The backlight layer 3 which is a transparent plastic sheet disposed under the sensing layer 2, and has a plurality of light emitting elements 31 corresponding to the first sensing block 213 and the first electrode block 214 and the second electrode block 223. Each of the light emitting elements 31 is electrically coupled and has a power transmission line 32 extended from the light emitting element 31. In this figure, the first light emitting element 311 and the second light emitting element 321 are light emitting diodes (LED), electroluminescent panels (EL) or (LED) backlights.

The base layer 4 is provided for carrying a combined member of the panel 1, the sensing layer 2 and the backlight layer 3.

The first sensing block 213 and second sensing block 215 are capacitive touch sensing element, and the second electrode block 223 is a resistive sensing element corresponding to the first electrode block 214 and the third electrode block 216.

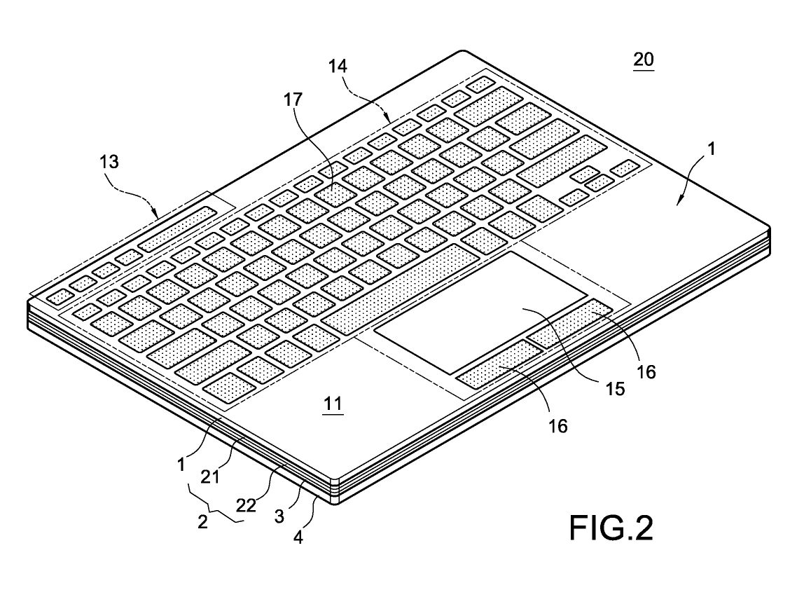

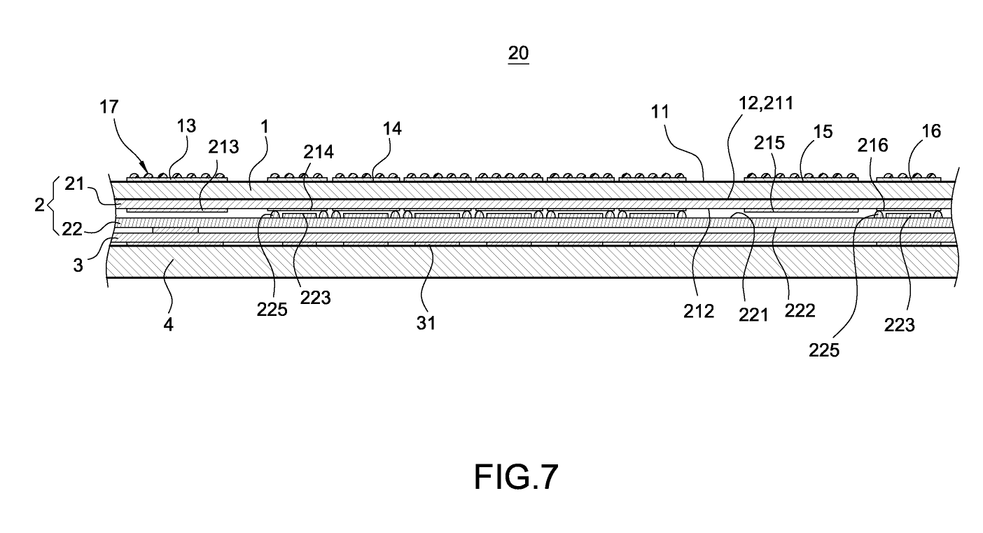

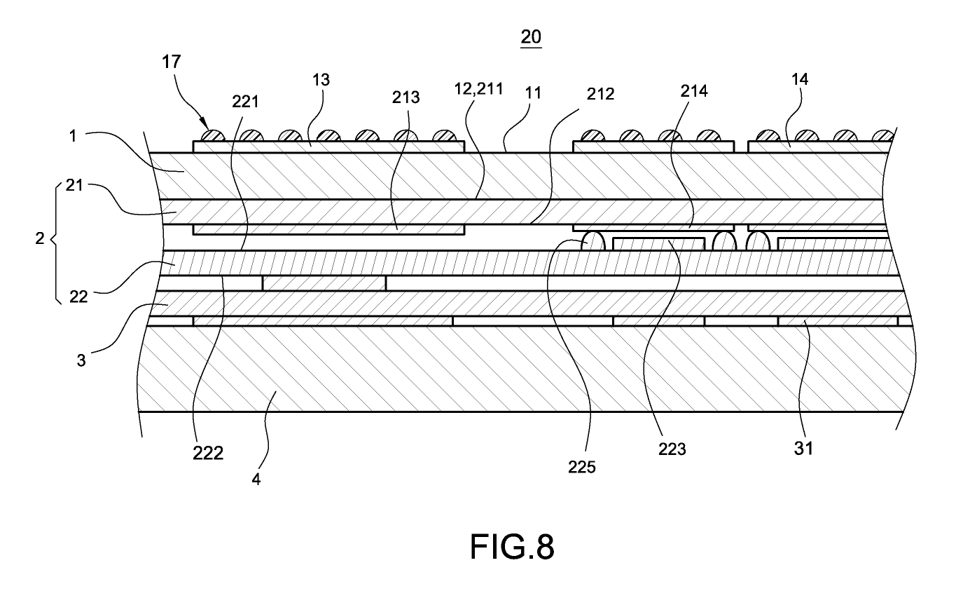

With reference to FIGS. 7 and 8 for a side cross-sectional view of FIG. 2 and a close-up view of FIG. 7 respectively, when a user enters an operation, the user touches the hot key pattern 13, the key group pattern 14, the cursor control pattern 15 or the sensing key pattern (left and right key patterns) 16 by a finger, and the user will touch the touch layer 17 on the surface of the hot key pattern 13, the key group pattern 14, the cursor control pattern 15 or the sensing key pattern (left and right key patterns) 16 first to let the user feel the touch of the press key.

After the user's finger touches the hot key pattern 13 on the panel 1, and the first sensing block 213 is sensed, the signal sensed by the first sensing block 213 is transmitted from the transmission line 213 to execute the corresponding function of the hot key.

When the user's finger presses on any press of the key group pattern 14, the first electrode block 214 is in contact with the second electrode block 223 for transmitting signal through the signal transmission line 214a, 224 to write various symbols, texts, numerals, upper and lower case letters and switch functions.

After a user's finger sliding on the cursor control pattern 15 is sensed by the second sensing block 215, the signal will be transmitted to a host computer (not shown in the figure) to control a cursor movement. After the cursor is moved on a pattern corresponding to an operation, and the third electrode block 216 and the second electrode block 223 are contacted with each other, the sensing key pattern 16 will execute the function corresponding to the pattern.

Since the membrane touch keyboard 20 is installed to the notebook computer 10, the manufacture of the notebook computer 10 becomes easier, and the thickness of the notebook computer 10 becomes smaller to achieve the light and thin design.

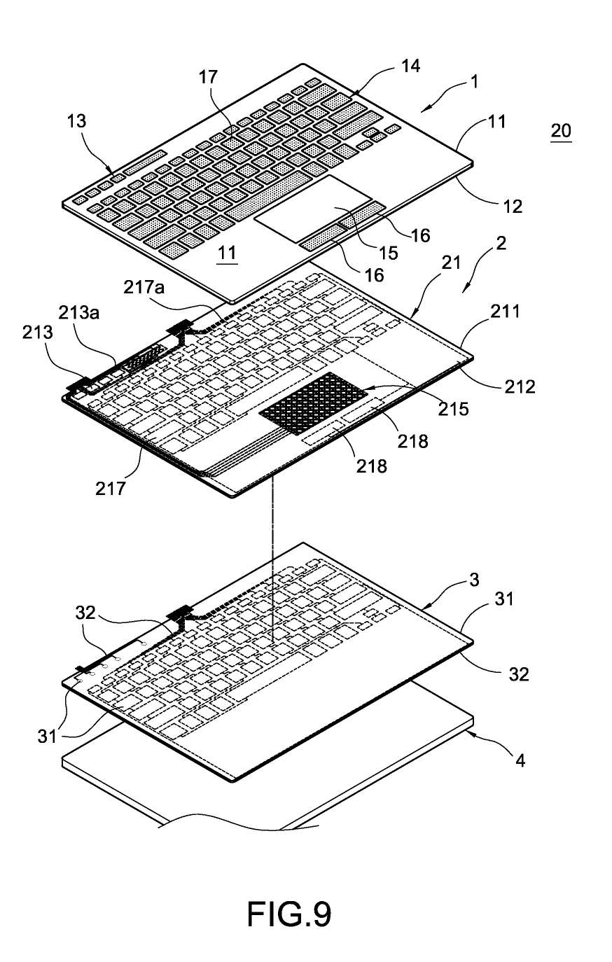

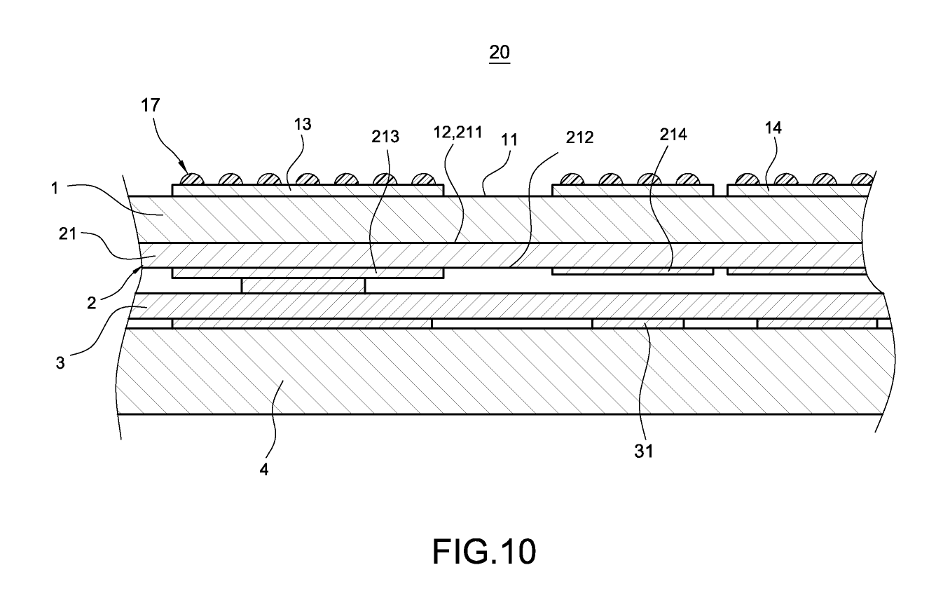

With reference to FIGS. 9 and 10 for side cross-sectional views of in accordance with another preferred embodiment of the present invention, the membrane touch keyboard 20 includes a plurality of third sensing blocks 217 and a fourth sensing block 218 printed on a first backside 212 of the first transparent layer 21, and each third sensing block 217 is electrically coupled, and the third sensing block 217 and the fourth sensing block 218 are provided for substituting the first electrode block 214, the third electrode block 216 and the second electrode block 223, and corresponding to the key group pattern 14 and the sensing key pattern 16, and coupled to a plurality of transmission lines 217a. In the manufacture of the membrane touch keyboard 20 of the notebook computer, the manufacturing time, process and cost of the second transparent layer 22 can be saved, such that the key group pattern 14 forms a capacitive touch sensing to make the manufacture simpler and easier.

While the invention has been described by means of specific embodiments, numerous modifications and variations could be made thereto by those skilled in the art without departing from the scope and spirit of the invention set forth in the claims.

What is claimed is:

1. A membrane touch keyboard structure for notebook computers, comprising:
a panel, including a key group pattern and a cursor control pattern; and
a sensing layer, including a first transparent layer and a second transparent layer, the first transparent layer including a first front side and a first backside, the first backside including a plurality of first electrode blocks and a second sensing block, the plurality of first electrode blocks being corresponding to the key group pattern, the second sensing block being corresponding to the cursor control pattern;
wherein the second transparent layer includes a second front side and a second backside, the second front side includes a plurality of second electrode blocks corresponding to the first electrode blocks respectively, the second electrode block includes a convex body provided for forming a spacing between the corresponding first electrode block and the second electrode block.

2. The membrane touch keyboard structure of claim 1, wherein the panel further comprises a plurality of hot key patterns and at least one sensing key pattern, and the panel is a transparent plastic sheet.

3. The membrane touch keyboard structure of claim 2, wherein each of the key group pattern, the cursor control pattern, the plurality of hot key patterns and the sensing key pattern includes a touch layer composed of a plurality of protrusions.

4. The membrane touch keyboard structure of claim 3, wherein the first transparent layer and the second transparent layer are composed of two transparent plastic sheets.

5. The membrane touch keyboard structure of claim 4, wherein the first backside further includes a plurality of first sensing blocks and a third electrode block, the plurality of first sensing blocks correspond to the plurality of hot key patterns, the third electrode block corresponds to the sensing key pattern, and the first sensing block is coupled to a plurality of transmission lines.

6. The membrane touch keyboard structure of claim 5, wherein the second front side includes a plurality of second electrode blocks corresponding to the third electrode block, and the second electrode block includes a convex body, the convex body has a spacing formed between the corresponding second electrode block and third electrode block, the plurality of second electrode blocks are electrically coupled, and the second electrode block is coupled to a plurality of signal transmission lines.

7. The membrane touch keyboard structure of claim 6, wherein the plurality of first electrode blocks is electrically coupled, and the first electrode blocks are coupled to the plurality of signal transmission lines.

8. The membrane touch keyboard structure of claim 7, wherein the third electrode block and the first electrode block are electrically coupled.

9. The membrane touch keyboard structure of claim 8 further comprising a backlight layer disposed under the sensing layer and being a transparent plastic sheet, the backlight layer having a plurality of light emitting elements corresponding to the first sensing block and the first electrode block and the second electrode block, and the light emitting elements being electrically coupled and each light emitting element having a power transmission line.

10. The membrane touch keyboard structure of claim 9, wherein the light emitting element is a light emitting diode (LED), an electroluminescent panel or an LED backlight panel.

11. The membrane touch keyboard structure of claim 10, further comprising a base layer for carrying a combination of the panel, the sensing layer and the backlight layer.

12. A membrane touch keyboard structure for notebook computers, comprising:
a panel, including a key group pattern and a cursor control pattern; and
a sensing layer including a first transparent layer, the first transparent layer including a first front side and a first backside, the first backside including a plurality of third electrode blocks and a second sensing block, the plurality of third electrode blocks being corresponding to the key group pattern, and the second sensing block being corresponding to the cursor control pattern.

13. The membrane touch keyboard structure of claim 12, wherein the panel further comprises a plurality of hot key patterns and a sensing key pattern, and the panel is a transparent plastic sheet.

14. The membrane touch keyboard structure of claim 13, wherein the first backside includes a plurality of first sensing blocks and a fourth sensing block, the plurality of first sensing blocks correspond to the plurality of hot key patterns respectively, the fourth sensing block corresponds to the sensing key pattern, and the first sensing blocks are coupled to a plurality of transmission lines respectively.

15. The membrane touch keyboard structure of claim 14, wherein the plurality of third sensing blocks are electrically coupled, and the third sensing blocks are coupled to the plurality of signal transmission lines.

16. The membrane touch keyboard structure of claim 15, wherein the fourth sensing block and the third sensing block are electrically coupled.

17. The membrane touch keyboard structure of claim 16, further comprising a backlight layer disposed under the sensing layer, a transparent plastic sheet disposed on the backlight layer, and a plurality of light emitting elements installed on the corresponding first sensing block and third sensing block, the light emitting elements are electrically connected, and each light emitting element has a power transmission line extended from the light emitting element.

18. The membrane touch keyboard structure of claim 17, wherein the light emitting element is a light emitting diode (LED), an electroluminescent (EL) panel or an LED backlight panel.

19. The membrane touch keyboard structure of claim 18, further comprising a base layer for carrying a combination of the panel, the sensing layer and the backlight layer.

20. The membrane touch keyboard structure of claim 19, wherein each of the plurality of hot key patterns, key group patterns, cursor control patterns and sensing key patterns has a touch layer dispose on a surface thereof, and the touch layer is formed by a plurality of protrusions.
